(19) United States
(12) Patent Application Publication
(10) Pub. No.: US 2024/0407072 A1
(43) Pub. Date: Dec. 5, 2024

(54) FLUORESCENT COLORED LIGHT EMITTING DIODE AND CONTROL SYSTEM FOR CREATING A LIGHT DISPLAY

(71) Applicant: FULLY ELECTRONICS CO., LTD, Putian (CN)

(72) Inventor: Jinchun He, Putian (CN)

(21) Appl. No.: 18/735,139

(22) Filed: Jun. 5, 2024

Related U.S. Application Data
(63) Continuation-in-part of application No. 18/342,491, filed on Jun. 27, 2023, now Pat. No. 12,035,442.
Application No. 18/342,491 is a continuation of application No. 17/938,571, filed on Oct. 6, 2022, now Pat. No. 11,729,890.
Application No. 17/938,571 is a continuation of application No. 17/361,139, filed on Jun. 28, 2021, now Pat. No. 11,483,915.
Application No. 17/361,139 is a continuation of application No. 17/029,207, filed on Sep. 23, 2020, now abandoned.

(51) Int. Cl. H05B 47/17; A43B 3/36; F21S 9/02; F21S 10/06; F21V 23/00; F21V 23/04; F21Y 115/10; H01H 1/14; H01H 13/14; H05B 45/10

(52) U.S. Cl. CPC H05B 47/17; A43B 3/36; F21S 9/02; F21S 10/06; F21V 23/007; F21V 23/0407; F21V 23/0492; H01H 1/14; H01H 13/14; H05B 45/10; F21Y 2115/10

(57) ABSTRACT

The invention involves a system and method for creating various light displays on a shoe or similar item. The system includes an IC chip that receives electrical signals from a MEMS chip or from multi-axis accelerometers to cause the IC chip to provide different light displays and sequences in response to the signals from the MEMS chip. The system also utilizes one or more LEDs that include a fluorescent to create different visible colors of light from a base LED having a single color which causes the fluorescent to illuminate.

### PRIORITY CLAIM

In accordance with 37 C.F.R. 1.76, a claim of priority is included in an Application Data Sheet filed concurrently herewith. Accordingly, the present invention claims priority as a Continuation-In-Part of U.S. patent application Ser. No. 18/342,491, entitled “SHOE LIGHT DEVICE CAPABLE OF FLASHING IN DIFFERENT MODES AND DRIVING METHOD THEREOF”, filed Jun. 27, 2023, which is a Continuation of U.S. patent application Ser. No. 17/938,571, entitled “SHOE LIGHT DEVICE CAPABLE OF FLASHING IN DIFFERENT MODES AND DRIVING METHOD THERE”, filed Oct. 6, 2022; which is Continuation of U.S. patent application Ser. No. 17/361,139, entitled “SHOE LIGHT DEVICE CAPABLE OF FLASHING IN DIFFERENT MODES AND DRIVING METHOD THERE”, filed Jun. 28, 2021, now U.S. Pat. No. 11,483,915, issued on Oct. 25, 2022; which was a Continuation of U.S. Non-Provisional patent application Ser. No. 17/029,207, entitled “SHOE LIGHT DEVICE CAPABLE OF FLASHING IN DIFFERENT MODES AND DRIVING METHOD THEREOF”, filed Sep. 23, 2020. The contents of the above referenced applications are incorporated herein by reference in their entirety.

### FIELD OF INVENTION

The present invention generally relates to light emitting diodes and, more particularly, to a light emitting diode that utilizes fluorescence to provide colored light. The fluorescent colored LED light is particularly useful for lighting devices, such as shoes, with decorative light sequences. The present disclosure also discloses a light display control system for determining a light display based upon user movement(s).

### BACKGROUND INFORMATION

It is known in the art to utilize LED lights to create lighting displays within a shoe in response to the shoe receiving a suitable impact to a ground surface to cause an impact switch to start the LEDs flashing in a predetermined light sequence. The light circuits are typically mechanical in nature, having the light sequence built into the circuitry such that only one light sequence is available. Once the sequence is displayed, the circuit resets for the next impact to cause the light sequence to run again.

One drawback to these standard designs is the limitation of the single sequence for display. Since the circuits are essentially mechanical, a different sequence requires a different circuit to be designed, severely limiting this design. As a result, the present inventors constructed a light circuit for a shoe that employs an integrated chip which allows the light sequence to be changed with programming instead of changing the circuit. This circuit also allows the light sequence to change from one sequence operation to the next sequence operation. These features are incorporated herein and are shown and described in U.S. Pat. Nos. 11,483,915, 11,265,979 and 11,729,890.

An additional drawback with previous light systems for shoes and with LEDs in general, relates to the construction of the LED lights themselves. LED lights, as they are currently known, require different voltage to produce different colors. This requirement results in serious design issues when a multicolored display is desired or when multiple LEDs are desired to be illuminated simultaneously. This situation is exacerbated when the LEDs are powered by one or more battery(s). Voltage requirements for LEDs range from about 1.6 volts to illuminate a red colored LED to 4.0 or more volts to illuminate a violet LED. Therefore, when different colored LEDs are placed in a parallel arrangement to receive power, the higher voltage LEDs are unlikely to light at all, with all of the available power going to the lower voltage LEDs. The different voltage requirements cause similar issues with series connections where the higher voltage LEDs have diminished illumination or no illumination, while the lower voltage LEDs burn too brightly or are destroyed from receiving too much voltage. Therefore, there is a need in the art for an LED design that can provide various colors while requiring the same or very similar voltage, simplifying design parameters and equalizing the illumination of the different colored LEDs.

Finally, because the prior art utilizes mechanical circuitry having a fixed light sequence, the only known means for starting the light sequence is an impact switch that includes a spring having a contact so that the spring contacts a tube to start the light sequence operation. The only modification is for the sequence to run more than once if the impact is substantial enough to register in a counter. These devices, however, cannot measure speed (velocity), angular velocities, radial velocities, distance, etc., and cannot provide a different light display as the result of a movement other than an impact.

Thus, the present invention provides a light display circuit that utilizes a microelectromechanical systems sensor (MEMS) to provide electrical signals to the integrated chip (IC) to cause different light display sequences as a result of different movements or actions of the shoe wearer. The present system also provides a unique construction of an LED that utilize a single color LED and various fluorescent(s) that react to the LED produced light to create light having different visible colors, but with each LED consuming the same or marginally different voltage and amperage.

### SUMMARY OF THE INVENTION

Briefly, the invention involves a system and method for creating various light displays on a shoe or similar item. The system includes an integrated chip (IC chip) that receives electrical signals from a microelectromechanical systems chip (MEMS chip) or from multi-axis accelerometers and/or GPS to cause the IC chip to provide different light displays and sequences in response to the signals from either the accelerometers, GPS, or the MEMS chip. The system also utilizes an LED that includes a fluorescent to create different visible colors of light from an LED(s) having a single color.

Accordingly, it is an objective of the present invention to provide an LED light that includes a fluorescent(s) that react to light up in response to illumination of the LED to provide visibly colored light.

It is a further objective of the present invention to provide a plurality of LEDs connected in series, wherein each LED consumes the same amount of electrical power while each LED produces different visibly colored light.

It is yet a further objective of the present invention to provide a plurality of LEDs connected in parallel, wherein each LED consumes the same amount of electrical power while each LED produces different visibly colored light.

It is another objective of the present invention to provide a decorative light circuit for a shoe that includes a MEMS chip in electrical cooperation with an IC chip to provide various light sequences.

It is still another objective of the present invention to provide a decorative light circuit for a shoe that includes a MEMS chip in electrical cooperation with an IC chip to provide different light sequence(s) in response to different movements of the shoe.

It is still yet another objective of the present invention to provide a decorative light circuit for a shoe that includes a MEMS chip in electrical cooperation with an IC chip to provide a light sequence(s) in response to acceleration movements of the shoe.

Still yet another objective of the present invention is to provide a decorative light circuit for a shoe that includes a MEMS chip in electrical cooperation with an IC chip to provide a light sequence(s) in response to positional movements of the shoe.

Other objectives and advantages of this invention will become apparent from the following description taken in conjunction with the accompanying drawings wherein are set forth, by way of illustration and example, certain embodiments of this invention. The drawings constitute a part of this specification, include exemplary embodiments of the present invention, and illustrate various objects and features thereof.

### BRIEF DESCRIPTION OF THE FIGURES

FIG. 1 is a top front left perspective view of a shoe assembly utilizing the light display of the present invention;

FIG. 2 is a circuit diagram of the shoe light device shown in the present inventor's prior patent which includes the IC chip and standard LEDs;

FIG. 3 is a section view illustrating a motion sensor used in the circuit illustrated in FIG. 2;

FIG. 4 is a section view of the motion sensor of FIG. 3 illustrating the motion sensor in a dynamic state;

FIG. 5 is a perspective view of the LEDs and their associated control circuit including a MEMS chip and the fluorescent LEDs.

FIG. 6 is an illustration showing the light spectrum of various forms of diodes;

FIG. 7 is an illustration showing the approximate frequency associated with various colors of light produced by LEDs;

FIG. 8 is an illustration showing a typical manufacturers data sheet for an LED;

FIG. 9 is an illustration showing color, wavelength and forward voltage for various colored LEDs;

FIG. 10 is a schematic view illustrating a typical series connection for a mechanical LED circuit;

FIG. 11 is a schematic view illustrating a typical parallel connection for a mechanical LED circuit;

FIG. 12A is a perspective illustration showing the construction of the anode and cathode of an LED;

FIG. 12B is a perspective illustration of the PN junction;

FIG. 13 is a perspective view of one embodiment of the present invention;

FIG. 14 is a schematic diagram of a circuit for the present invention;

FIG. 15 is a front view of a MEMS chip suitable for use with the present invention;

FIG. 16 is a schematic representation of the functions of the MEMS chip; and

FIG. 17 is a schematic representation of an embodiment that utilizes one or more accelerometers to control operation of the light display.

### DETAILED DESCRIPTION OF THE PREFERRED EMBODIMENTS

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiments illustrated.

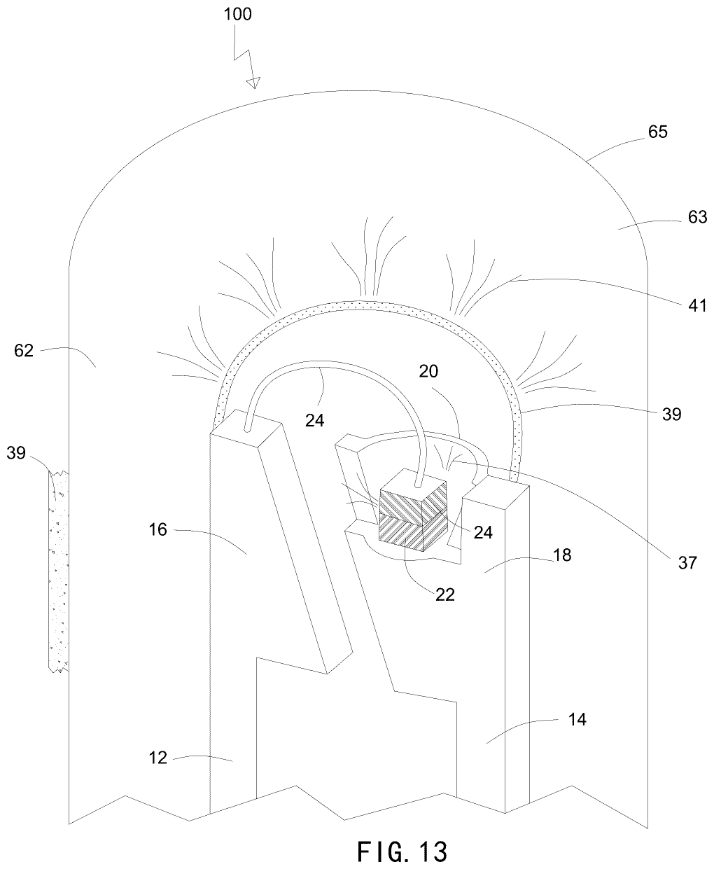

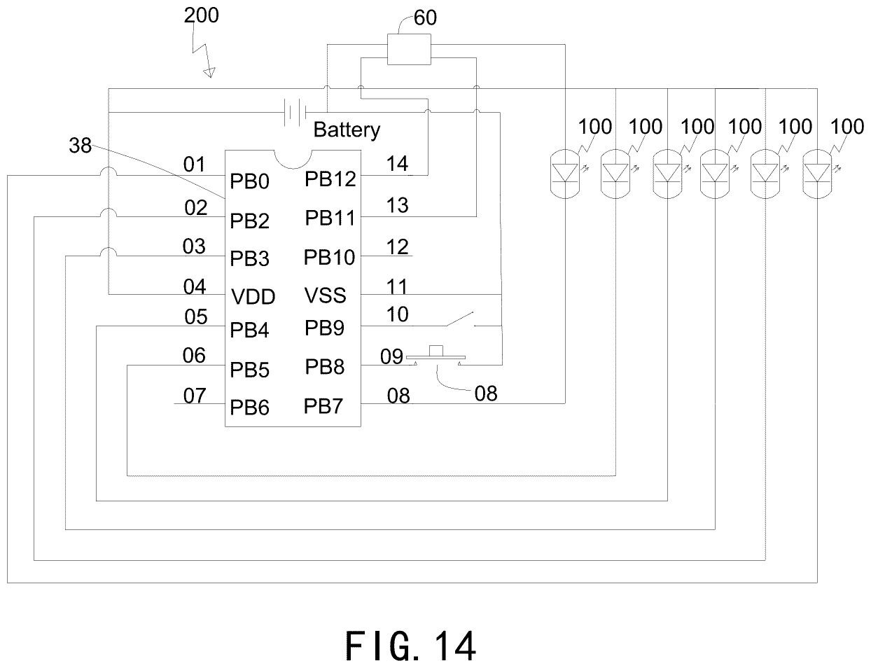

Referring generally to the figures, a fluorescent light emitting diode (LED) 100 (FIG. 13) that utilizes fluorescence to provide color and a control system 200 (FIG. 14) for controlling a light display based upon angular orientation and acceleration of the light display are illustrated. In general, LEDs and diodes both work on the same principle. They include a semiconductor material positioned in between electrical connectors. They both emit photons when electrical power is applied; however, the LEDs emit photons in a range that is visible to humans. Humans perceive different colors depending on the wavelength of the photons. The visible spectrum of light is typically considered to have a wavelength between 400 and 700 nanometers. Other devices also emit light in wavelengths that are either too long or too short to be visible to humans. For example, an FM radio emits a photon wave having a length of about three meters, a WIFI signal is smaller at around six centimeters, and a medical X-ray typically has a photon wavelength of about 0.01 nanometers. As previously stated, while LEDs come with various colored lenses, the lens color is only to make it easy to tell what color of light the LED produces and typically does not color the light emitted in any appreciable way. Instead, it is the materials used to construct the semiconductor of the LED that determine the color of light (photons) that will be produced and emitted.

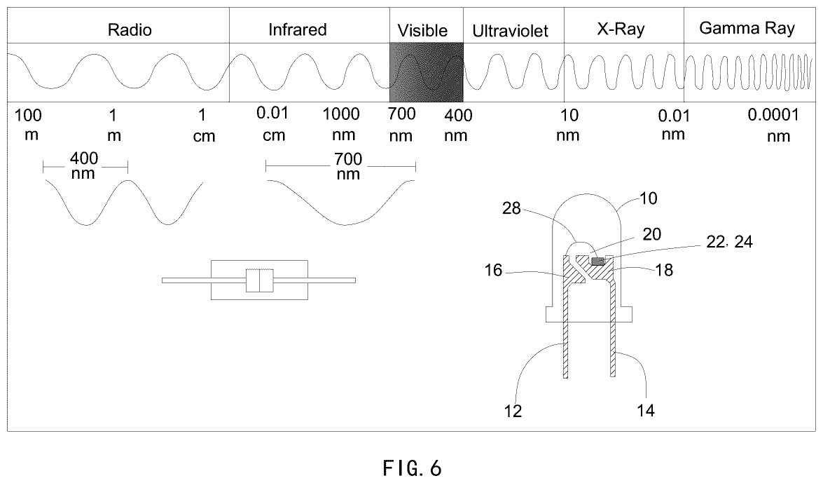

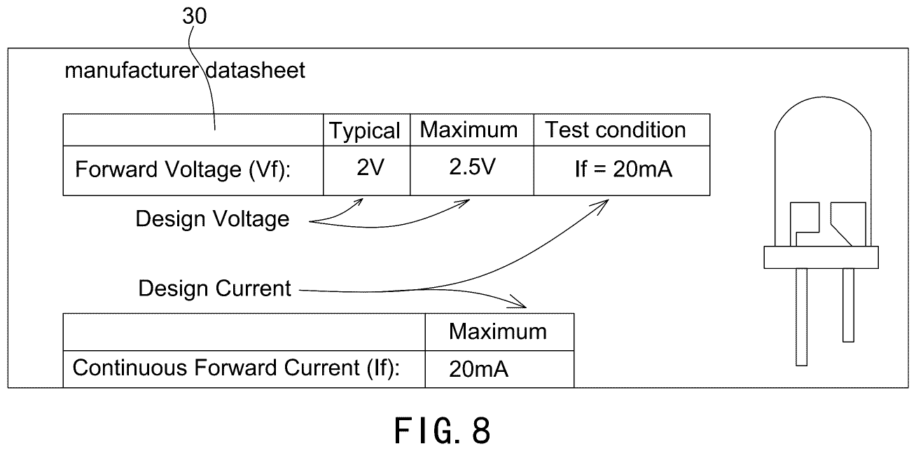

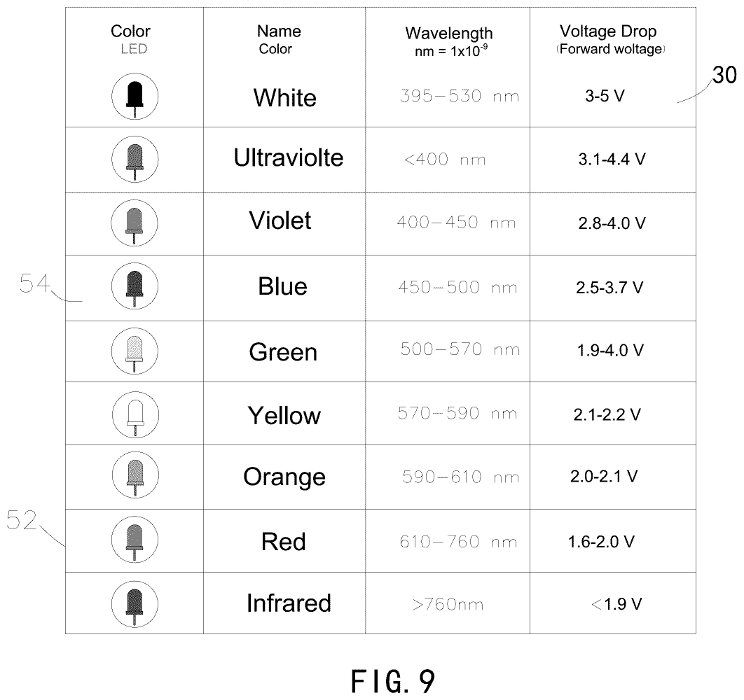

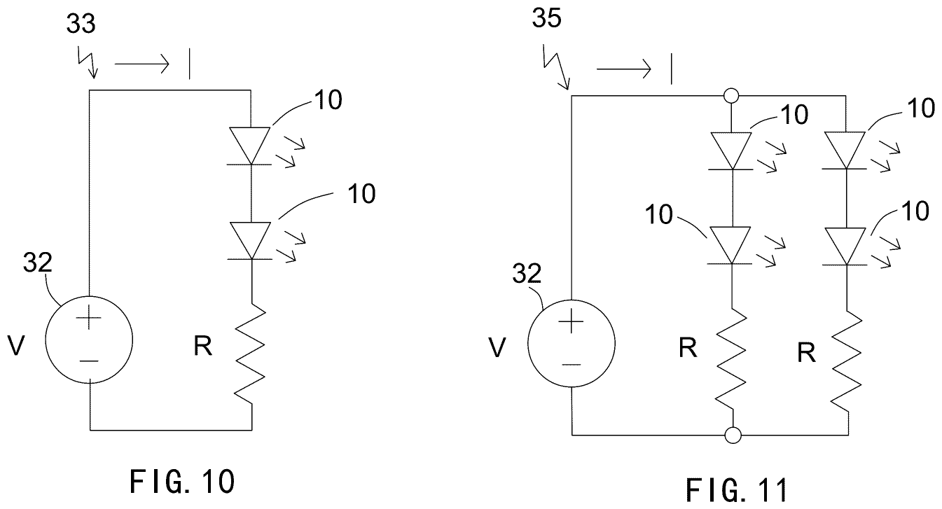

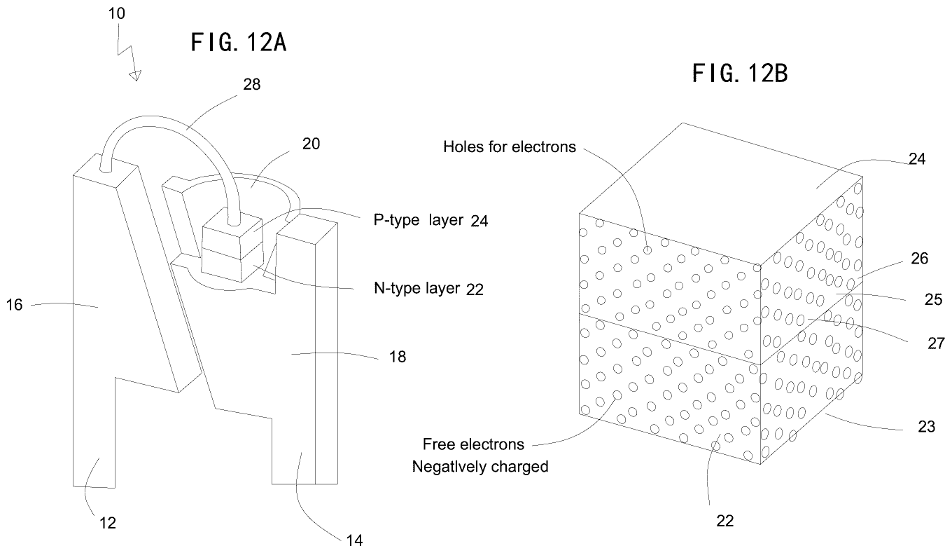

When we look at a standard LED 10 (FIGS. 6 and 12), there are two leads for connection to power. The longer lead is the anode 12, while the shorter lead is the cathode 14. Both the anode 12 and the cathode 14 each have a respective plate 16, 18 which are separated by a small gap so that they do not touch each other. The cathode plate 18 is generally larger than the anode plate 16. A cone 20 is typically positioned on the cathode plate 18. Within the cone 20, a small piece of an N-type semiconductor 22 is positioned with a P-type semiconductor 24 on top of the N-type semiconductor 22. This configuration forms the “PN junction” 26 as it known in the art. The N-type semiconductor layer 22 is constructed to have lots of places for free electrons to position themselves, while the P-type semiconductor layer 24 is missing electrons and includes several positions for electrons to move from the N-type semiconductor layer. The N-type semiconductor layer 22 is negatively charged while the P-type semiconductor layer 24 is positively charged. A connection wire 28 extends between the anode 12 and the P-type semiconductor layer 24 to complete the circuit. Thus, when the standard LED 10 is powered, photons are emitted from the PN junction 26 as the electrons move across the PN junction, which produces colored light. The cone 20 reflects the light out of the LED to make the light more visible. The color of the light depends on the wavelength of the photon emitted from the semiconductor, and that depends on the materials used to construct the semiconductor. At the PN junction 26, an electron barrier is created having an area that includes a slightly positive charged region and a slightly negatively charged region. This creates an electric field that functions as the barrier and prevents more electrons from moving across the PN junction 26 without being connected to a battery. When a battery or other power source is connected across the anode 16 and cathode 18, the electrons will flow across the PN junction barrier; this is termed “forward bias” in the art. This forward bias is determined by the materials that are used to construct the N-type semiconductor layer 22 and the P-type semiconductor layer 24, which also determines the color of the light produced from the LED when powered and the amount of power that it takes to cause the LED to illuminate. Thus, LEDs are supplied with a manufacturer datasheet (FIG. 8) which identifies the forward voltage 30 for a particular LED of a particular color. FIG. 9 illustrates the forward voltage 30 of various colored LEDs from a supplier. These forward voltages 30 vary from less than 1.9 volts to 5 volts depending on the forward voltage and the color of illumination. For example, a red LED 52 (FIG. 9) shows a wavelength of 610-760 nm and the forwarding voltage is 1.6-2.0 volts. These voltages may vary slightly between manufacturers; however, there always remains a difference in voltage for different colored photons of light that are produced. The different voltages create significant issues when designing light displays that utilize different colored LEDs. For example, FIG. 10 illustrates a series circuit 33 having two standard LEDs 10. In this circuit, if the voltage source is a watch battery 32 (1.5 volts), only one of the two LEDs in the circuit could be powered and only an infrared LED, the other LED would not receive sufficient power to exceed the forward voltage and it would not light up, regardless of color. If a plurality of batteries were connected in series to produce 6 volts, for example, and one LED was a red LED (2.0 volts) first in line, while the other LED was a green LED (4.0 volts), the red LED would light up much brighter than the green LED because the voltage is significantly higher than the forward voltage required to light the red LED. In the situation of the red LED being positioned in front of the green LED, the red LED may even be subject to an overcurrent condition, resulting in burn out of the red LED. FIG. 11 illustrates a parallel connection of LEDs 35. In this example, one string of the LEDs may not light at all if the forward voltage is not sufficiently high, while the other string may light correctly or may be supplied with an overcurrent. This issue creates significant problems for some industries. One such industry is the shoe industry, where LED displays are common in shoes.

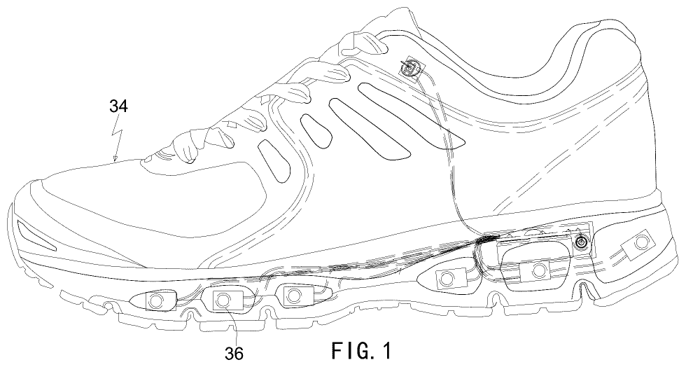

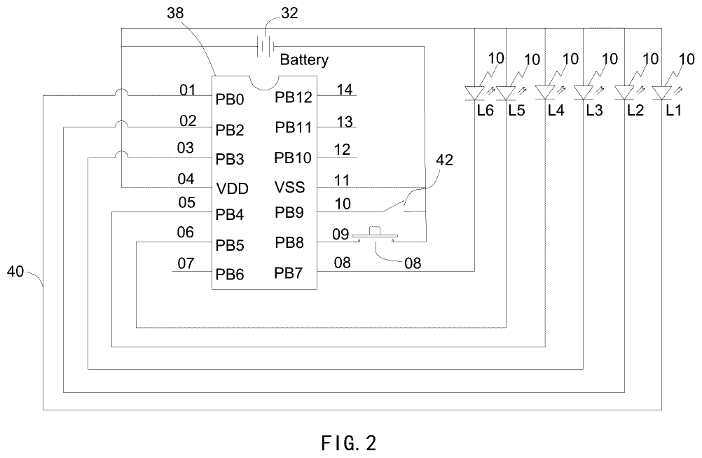

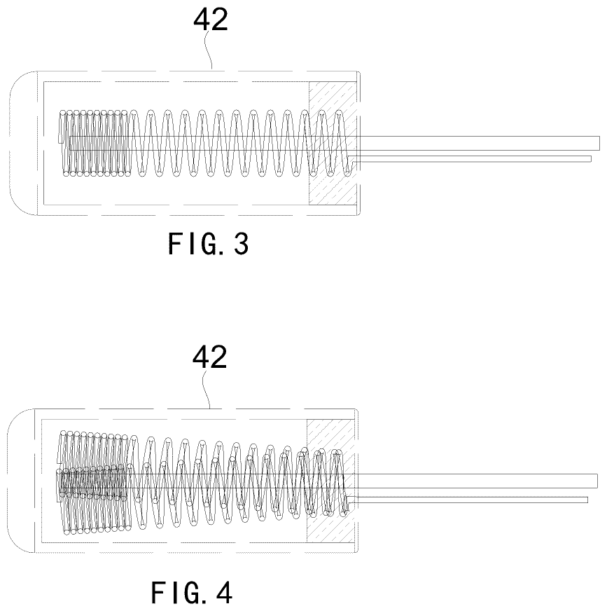

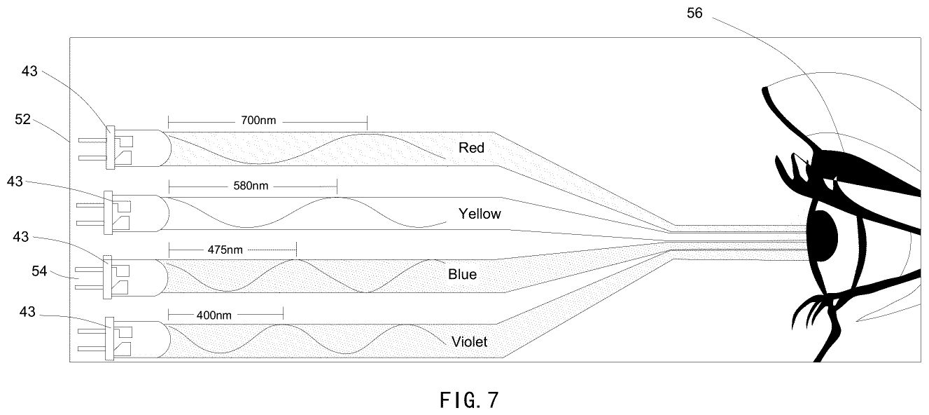

FIG. 1 illustrates a shoe 34 having an LED light display 36 activated by impact of the shoe to a surface. The circuit for the shoe 34 is illustrated in FIG. 2. This prior art device, assigned to the present inventor, is embodied in U.S. Pat. Nos. 11,483,915, 11,265,979 and 11,729,890, the contents of which are incorporated by reference herein. The circuit includes an integrated chip 38 having memory therein for operation of the LEDs 10 in a predetermined sequence. Each LED is provided with an independent ground 40 for independent operation of each LED. The light display may be started by an impact switch 42, shown in a static position in FIG. 3 and in dynamic operation in FIG. 4. Thus, as illustrated, the entire circuit has a single power supply, e.g. batteries, for operation of multiple LEDs, each of which, if different in color, has a different forward voltage 30 requirement. Thus, some combinations may not be possible to light, or some LEDs may be required to be illuminated with another LED or a resistor to reduce voltage to prevent overcurrent of the LED. Thus, in order to correct the issue of different colored standard LEDs 10 from being an issue, the present system provides a fluorescent LED 100 (FIG. 13). The fluorescent LED utilizes a single base color of photon Lightwave 37, for example blue base light 43, having a light wavelength from 450-500 nm of blue light 43 which forms the first wavelength 45 to produce multiple colors of visible light using a layer of fluorescent(s) 39 that react to the base light. The base light is absorbed by the fluorescent 39 to produce visible light of a second wavelength 41, and thus a second color which is visible to humans. In this manner, the multiple LEDs can be connected in series or parallel, wherein each fluorescent LED 100 has the same or substantially similar forward voltage requirements to illuminate. In a preferred embodiment (FIG. 13), the fluorescing LED 100 includes two leads for connection to power, which may be battery, capacitor, solar, household current or the like. The longer lead is the anode 12, while the shorter lead is the cathode 14. It should be noted that surface mount fluorescent LEDs may have the same length anode and cathode without departing from the scope of the invention. Both the anode 12 and the cathode 14 each have a respective plate 16, 18 which are separated by a small gap so that they do not touch each other. The cathode plate 18 is generally larger than the anode plate 16. A cone 20 is typically positioned on the cathode plate 18. Within the cone 20, a small piece of an N-type semiconductor 22 is positioned with a P-type semiconductor material 24 on top of the N-type semiconductor 22. The N-type semiconductor (22) includes a first side surface (23) positioned adjacent the cathode plate (18) and secured to the cathode plate in a suitable manner. The P-type semiconductor (24) has a first side surface (25) positioned adjacent a second side surface (27) of the N-type semiconductor (22) so that the second side surface (27) of the N-type semiconductor (22) and the first side surface (25) of the P-type semiconductor (24) are in contact with each other to define a “PN semiconductor junction” (26) or “PN junction”, as it known in the art. The N-type semiconductor 22 is constructed to have lots of places for free electrons to position themselves, while the P-type semiconductor 24 is missing electrons and includes several positions for electrons to move from the N-type semiconductor 22. The N-type semiconductor 22 is negatively charged, while the P-type semiconductor is positively charged. A connection wire 28 extends between the anode 12 and the P-type semiconductor 24 to complete the circuit. A layer of fluorescent 39 is positioned between the base color light produced by the PN junction 26 and the viewer's eye 56 (FIG. 7). Thus, the LEDs in FIG. 7 are all producing the same base color photons producing the same color of light while the viewer is seeing the color of photons emitted from the fluorescent. The fluorescent 39 is constructed and arranged to absorb electromagnetic radiation, typically from ultraviolet or visible light. The fluorescent molecule absorbs the electromagnetic radiation and emits a photon of a lower energy, smaller frequency or longer wavelength. This causes the light that is emitted from the fluorescent to have different visible color than the base light that was originally absorbed by the fluorescent 39. The fluorescent 39 may be positioned as a spherical or semi-spherical layer within the epoxy 62 which forms the LED cover lens 63, or it may simply be a coating on the PN semiconductors 22, 24 without departing from the scope of the invention. Alternatively, the fluorescent 39 may take any other shape within the epoxy lens that is suitable to produce visible light some of which may allow partial visibility of the base light. In other embodiments, the fluorescent 39 may be positioned on an outer surface 65 of the LED lens cover 63 (FIG. 13). Typically, the excited state is dependent upon the photons from the LED, and thus the excited lifetime is dependent upon the LED being illuminated. In another embodiment, the fluorescent may be a phosphorescence, in which the phosphorescence material continues to glow after the LED has been turned off. The fluorescent LED arrangement is particularly suited for display items such as shoes, as shown in FIG. 1 where the power supply for the LED power is limited and the desire for dynamic light displays is strong. The fluorescent LED 100 of the present device is suitable for replacing LEDs in old and new light displays alike. In particular, the present fluorescent LED 100 is particularly suited for replacing the standard LEDs 10 of FIGS. 1 and 2 with the present fluorescent LEDs 100 to provide better control of the LEDs and allow a more diverse group of light displays. In yet another embodiment, the impact switch 42 is replaced with a MEMS chip or a group of multi-axis accelerometers and/or GPS chips. In this manner, the light displays can be triggered and/or selected based upon the type of movement that is applied to the shoe. The prior art only allowed starting the light display upon an impact. In contrast, a MEMS chip 60 (FIG. 14) connected to the IC chip 38 allows the light display to start upon an angular velocity, an acceleration, or a displacement from an original point.

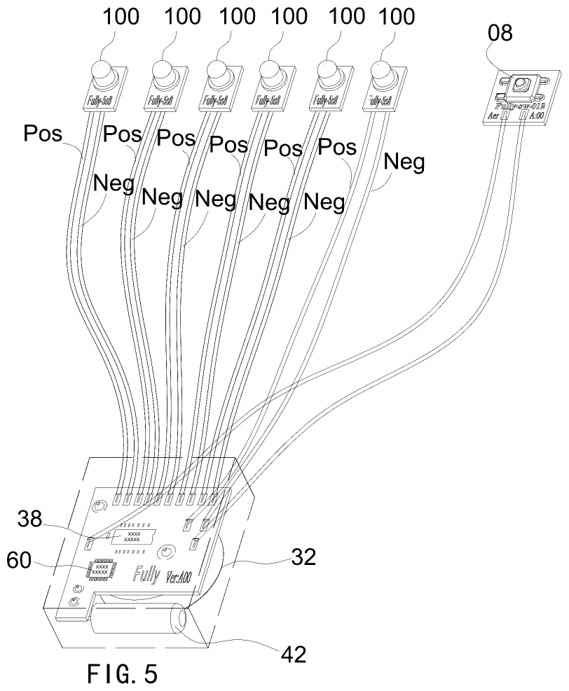

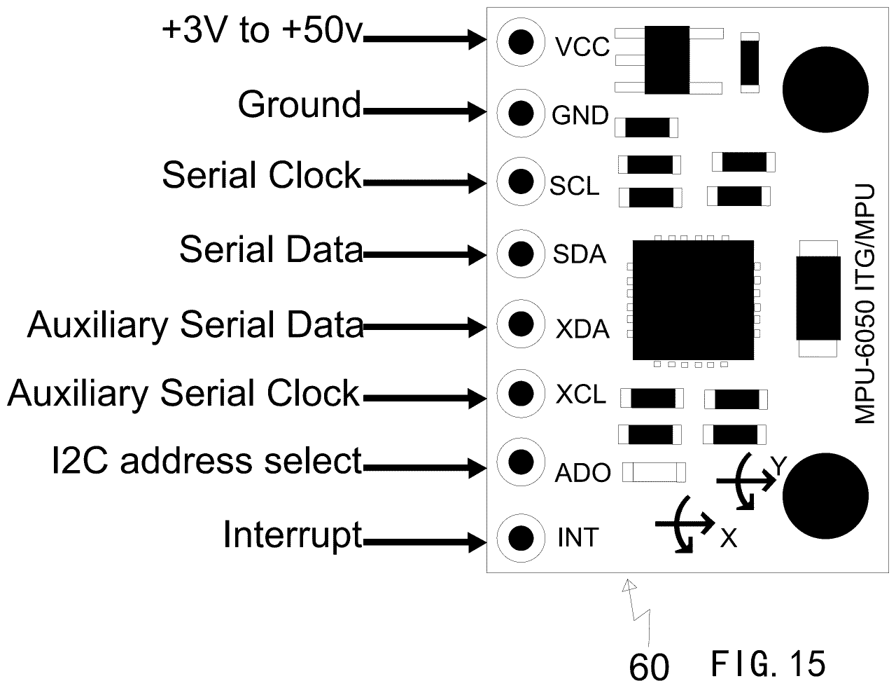

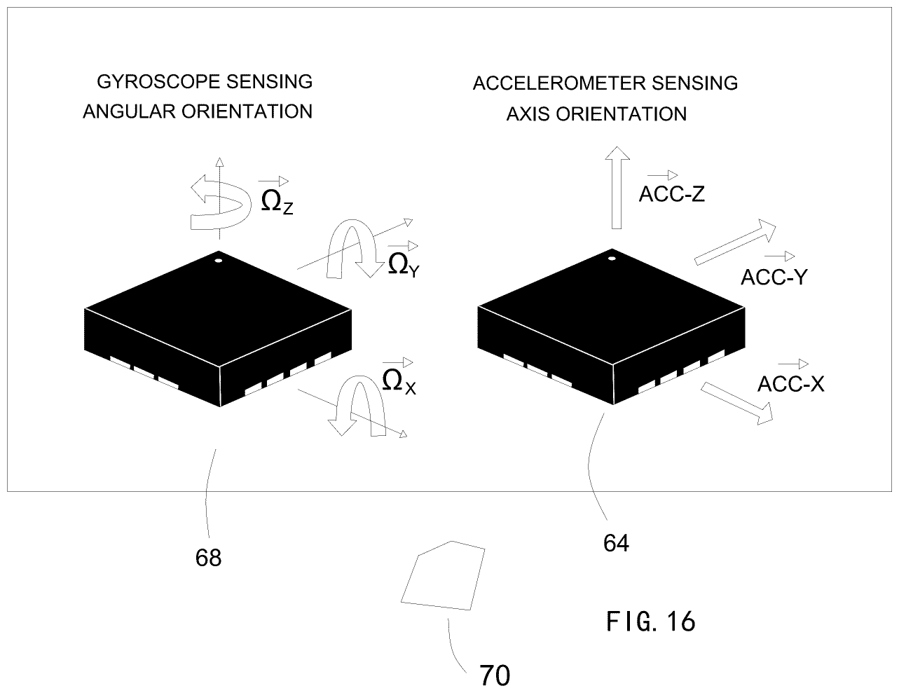

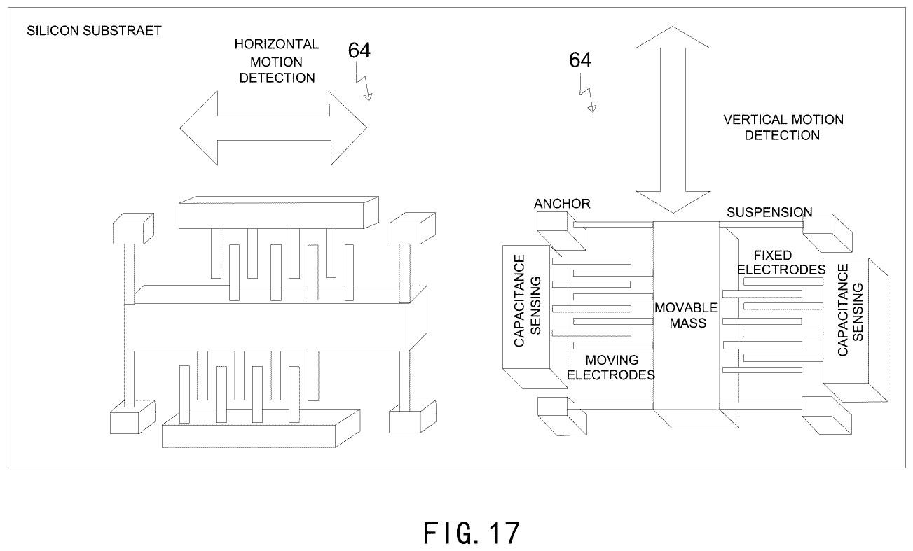

Still referring generally to the figures and more specifically to FIGS. 5 and 14-17, a circuit suitable for illuminating a shoe 34 is illustrated. Accelerometers 64 are electromechanical devices that measure acceleration, e.g. the rate of change of velocity of an object. Piezoelectric accelerometers are a well-known example of commonly used accelerometers. A capacitive microelectromechanical systems (MEMs) chip 60 (FIG. 15) measures the capacitive changes in seismic mass under acceleration. The capacitive sensors are oriented in different planes within the MEMs chip 60 to measure acceleration along different axes. They excel in measuring low-frequency motion, vibration and steady state acceleration. Thus, they are the preferred choice for connection in the shoe light display with the fluorescent LEDs. The MEMs chip 60 is configured to cooperate with the IC chip 38 to provide signals to the IC chip regarding acceleration, displacement, angular acceleration, etc., to allow the IC chip to choose a light sequence and display that light sequence on the fluorescent LEDs 100. A gyroscope 68 may also be positioned within the MEMs chip 60 to measure angular acceleration and orientation of the object, such as the shoe. In this manner, light displays can be chosen and/or activated based upon angular movements of the shoe, for example dancing. Thus, the MEMs chip 60 can measure and provide a light display where the prior art would cease to measure the movement or provide a response to the movement. In still other embodiments, a global positioning chip 70 (GPS) may be added to the system to provide light displays based upon displacement or reaching a particular destination, etc. The MEMs chip 60 and the GPS chip 70 are readily connected to the IC chip 38 and easily programmable using known programming techniques to provide the light displays based upon the various parameters.

It is to be understood that while a certain form of the invention is illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention, which are obvious to those skilled in the art, are intended to be within the scope of the following claims.

1. A fluorescent light emitting diode assembly (100) comprising:
an anode (12) having a first end for electrical connection to a positive source of power, a second end of the anode (12) in electrical communication with an anode plate member (16),
a cathode (14) having a first end for electrical connection to a negative source of power, a second end of the cathode (14) in electrical connection with a cathode plate member (18), the anode plate (16) and the cathode plate (18) separated by a gap so to not contact each other,
an N-type semiconductor (22) having a first side surface (23) positioned adjacent the cathode plate (18) and secured to the cathode plate,
a P-type semiconductor (24) having a first side surface (25) positioned adjacent a second side surface (27) of the N-type semiconductor (22) so that the second side surface (27) of the N-type semiconductor (22) and the first side surface (25) of the P-type semiconductor (24) are in contact with each other to define a PN semiconductor junction (26),
a connection wire (28) extending between the anode (12) and the P-type semiconductor (24) to complete the electrical circuit, wherein the source of power is applied to the anode (12) and the cathode (14) to cause photons of a first color to be emitted from the PN semiconductor junction (26),
a layer of fluorescent (39) positioned to absorb the photons of the first color emitted from the PN semiconductor junction (26) and produce a second group of photons having a second visible color.

2. The fluorescent light emitting diode assembly (100) of claim 1 including a cover lens (63) for positioning the fluorescent (39) in proximity to the PN semiconductor junction (26).

3. The fluorescent light emitting diode assembly (100) of claim 2 wherein the fluorescent (39) is positioned internally with respect to the cover lens (63).

4. The fluorescent light emitting diode assembly (100) of claim 3 wherein the fluorescent (39) includes a partial spherical shape within the cover lens (63).

5. The fluorescent light emitting diode assembly (100) of claim 3 wherein the fluorescent (39) includes a planar shape within the cover lens (63).

6. The fluorescent light emitting diode assembly (100) of claim 2 wherein the fluorescent (39) is positioned on an outer surface of the cover lens (63).

7. The fluorescent light emitting diode assembly (100) of claim 1 including a cone (20) positioned on the cathode plate (18) to at least partially encircle N-type and P-type semiconductors (22, 24), the cone (20) being constructed and arranged to reflect photons away from the cathode plate (18).

8. The fluorescent light emitting diode assembly (100) of claim 2 wherein the photons emitted from the fluorescent light emitting diode (100) are in the visible spectrum of light.

9. The fluorescent light emitting diode assembly (100) of claim 8 wherein the photons emitted have a wavelength between 400 nanometers and 700 nanometers.

10. The fluorescent light emitting diode assembly (100) of claim 1 including an integrated chip (38) having memory therein for storing illumination sequences for illumination of a plurality of the fluorescent light emitting diodes (100) in a predetermined sequence, each fluorescent light emitting diode (100) is provided with an independent ground (40) for independent operation of each fluorescent light emitting diode (100).

11. The fluorescent light emitting diode assembly (100) of claim 10 wherein each of the plurality of fluorescent light emitting diodes (100) requires the same amount of forward voltage (30) and produces a different color of photons in the form of visible light when illuminated.

12. The fluorescent light emitting diode assembly (100) of claim 11 wherein each of the plurality of fluorescent light emitting diodes (100) produces the same first color of light photons for absorption by the fluorescent (39).

13. The fluorescent light emitting diode assembly (100) of claim 11 wherein the first color of light photons is blue 43.

14. The fluorescent light emitting diode assembly (100) of claim 10 including a microelectromechanical systems chip (60) electrically connected to the integrated chip (38) for initiating the predetermined light sequence in response to acceleration of the microelectromechanical systems chip (60).

15. The fluorescent light emitting diode assembly (100) of claim 10 including a global positioning chip (70) for initiating the predetermined light sequence in response to displacement of the global positioning chip (70).
